(19) United States
(12) Patent Application Publication
(10) Pub. No.: US 2008/0316248 A1
(43) Pub. Date: Dec. 25, 2008

(54) METHOD AND APPARATUS TO DETECT TEMPERATURE OF PRINTHEAD FOR INKJET PRINTER

(75) Inventors: Jun-ho LEE, Suwon-si (KR); Seong-nam JEON, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/025,229

(22) Filed: Feb. 4, 2008

(30) Foreign Application Priority Data
Jun. 25, 2007 (KR) 2007-62488

(51) Int. Cl. G01K 13/00; B41J 29/393

(52) U.S. Cl. 347/19; 374/141; 374/E13.001

(57) ABSTRACT

A method and apparatus to detect the temperature of an inkjet head are provided. A method of detecting the temperature of an inkjet head, comprising detecting an amount of printing data allocated to each of a plurality of unit head chips of the inkjet head, determining a detection frequency of temperature information on each of the plurality of unit head chips according to the detected amount of printing data, and detecting the temperature information on each of the plurality of unit head chips according to the determined detection frequency.

### CROSS-REFERENCE TO RELATED APPLICATIONS

This application claims the benefit of Korean Patent Application No. 10-2007-0062488, filed on Jun. 25, 2007, in the Korean Intellectual Property Office, the disclosure of which is hereby incorporated herein in its entirety by reference.

### BACKGROUND OF THE INVENTION

1. Field of the Invention

The present general inventive concept relates to an inkjet printer having an inkjet head, and more particularly, to a method and apparatus to detect temperature of unit head chips of an inkjet printer.

2. Description of the Related Art

In order to conventionally detect a temperature of each unit head chip of a wide array head type inkjet printer, a resistance value of each unit head chip is measured by driving a thermistor, the measured resistance values are amplified, and the amplified resistance values are applied to a multiplexer. The multiplexer sequentially outputs temperature information of each received unit head chip to a controller. The controller detects the temperature of each unit head chip by using the temperature information.

A temperature of each unit head chip is an important factor for determining image quality. Thus, detection of the temperature of each unit head chip greatly affects printing quality. When a print head supplies ink for chambers, heats a lower part of a chamber, and ejects ink onto a recording medium to print an image, its ejection capabilities are greatly affected by the temperature of the ink and variations in the temperature of the print head, i.e., the viscosity of the ink, variations in an ejection direction, wetting of the surface of the print head, variations in dot volume and the like. Therefore, it is necessary to efficiently access temperature variations that occur when printing the image onto the recording medium.

However, the amount of printing data allocated to each of the head chips varies according to the locations of the head chips in the wide array head type inkjet printer. Accordingly, since large variations in the amount of printing data allocated to the head chips causes large variations in temperatures of the head chips, a conventional method of sequentially detecting the temperature of head chips cannot properly sense temperature variations in the head chips.

### SUMMARY OF THE INVENTION

The present general inventive concept provides a method and apparatus to more precisely detect a temperature of a wide array head having a plurality of unit head chips by establishing a temperature detection frequency of the plurality of unit head chips based on an amount of printing data allocated to each unit head chip during a printing process.

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of detecting the temperature of an inkjet head, including detecting an amount of printing data allocated to each of a plurality of unit head chips of the inkjet head, determining a detection frequency of temperature information on each of the plurality of unit head chips according to the detected amount of printing data, and detecting the temperature information on each of the plurality of unit head chips according to the determined detection frequency.

The amount of printing data per page allocated to each of the plurality of unit head chips may be detected.

The amount of printing data per line allocated to each of the plurality of unit head chips may be detected.

The detection frequency of temperature information on each of the plurality of unit head chips may be determined by establishing a weight for each of the plurality of unit head chips in proportion to each amount of printing data.

The temperature information on each of the plurality of unit head chips may be repeatedly detected according to the determined detection frequency using a circulation process.

The operation of detecting the temperature information may further include detecting temperature information on the plurality of unit head chips according to an equal detection frequency.

The foregoing and/or other aspects and utilities of the present general inventive concept may also be achieved by providing a computer readable recording medium having embodied thereon a computer program to execute a method of detecting the temperature of an inkjet head, the method including detecting an amount of printing data allocated to each of a plurality of unit head chips of the inkjet head, determining a detection frequency of temperature information on each of the plurality of unit head chips according to the detected amount of printing data, and detecting the temperature information on each of the plurality of unit head chips according to the determined detection frequency.

The foregoing and/or other aspects and utilities of the present general inventive concept may also be achieved by providing an apparatus to detect temperature of an inkjet head, including a sensing unit to sense the temperature of a plurality of unit head chips of the inkjet head, and a control unit to establish a detection frequency based on an amount of printing data allocated to each unit head chip, and to detect the temperature of each unit head chip from the sensing unit based on the established detection frequency.

The control unit may alternate between an equal detection frequency and the established detection frequency when detecting the temperature of each unit head chip.

The detection frequency may vary according to the location of each unit head chip with respect to the inkjet head.

The control unit may repeatedly detect the temperature of each unit head chip until a page of printing data is completely printed, or the control unit may repeatedly detect the temperature of each unit head chip until a line of printing data is completely printed.

The control unit may establish a weight for each of the plurality of unit head chips in proportion to each amount of allocated printing data and may determine the detection frequency based on the established weights.

The control unit may repeatedly detect the temperature of each of the plurality of unit head chips according to the determined detection frequency using a circulation process.

The control unit may further detect temperature information on the plurality of unit head chips according to an equal detection frequency when detecting the temperature of each of the plurality of unit head chips.

The apparatus may further include an amplification unit to amplify the temperature result sensed by the sensing unit.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a flowchart illustrating a method of detecting a temperature of an inkjet head, according to an embodiment of the present general inventive concept;

FIG. 2 is a graph illustrating an amount of printing data allocated to each of a plurality of unit head chips, according to an embodiment of the present general inventive concept;

FIG. 3 is a graph illustrating detection frequencies of temperature information on each of the plurality of unit head chips that is determined according to a weight, according to an embodiment of the present general inventive concept;

FIG. 4 is a flowchart illustrating an operation of detecting the temperature information on each of the plurality of unit head chips, as illustrated in FIG. 1; and

FIG. 5 is a block diagram of an apparatus to detect the temperature of an inkjet head according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

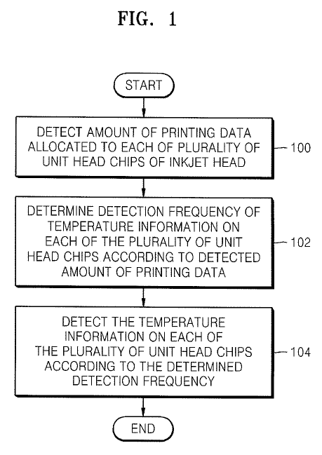

FIG. 1 is a flowchart illustrating a method of detecting a temperature of an inkjet head according to an embodiment of the present general inventive concept. Referring to FIG. 1, an amount of printing data allocated to each of a plurality of unit head chips of the inkjet head may be detected (Operation 100). It is understood that an amount of printing data per page can be allocated to each of the plurality of unit head chips, and/or an amount of printing data per line can be allocated to each of the plurality of unit head chips. For example, the amount of printing data allocated to each of the plurality of unit head chips may be detected to print a page, and/or the amount of printing data allocated to each of the plurality of unit head chips may be detected to print a line.

As illustrated in FIG. 1, a detection frequency of temperature information on each of the plurality of unit head chips may be determined according to the detected amount of printing data allocated to each unit head chip (Operation 102). In particular, a weight may be established for each of the plurality of unit head chips in proportion to the detected amount of printing data allocated to each unit head chip in order to determine the detection frequency of temperature information.

FIG. 2 is a graph illustrating the amount of printing data allocated to each of a plurality of unit head chips, according to an embodiment of the present general inventive concept. Referring to FIG. 2, if a wide array inkjet head has fourteen unit head chips, an amount of printing data may be allocated to each of the fourteen unit head chips. As illustrated in FIG. 2, the amount of printing data allocated to some of the unit head chips located near the center of the wide array inkjet head may be greater than that of the other unit head chips located near the side of the wide array inkjet head.

In Table 1 below, a weight may be established for each of the plurality of unit head chips in proportion to the amount of printing data.

TABLE 1

| | unit head chips | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| Weight | 1 | 2 | 2 | 2 | 2 | 4 | 4 | 4 | 4 | 3 | 3 | 3 | 1 | 1 |

Referring to Table 1, the weight for each head chip is in the range of 1 through 4, although other ranges may be used without departing from the principles and spirit of the present general inventive concept. The weight may then be used to determine the detection frequency of temperature information of each of the plurality of unit head chips, as described in more detail below.

The detection frequency of temperature information is a value indicating what period of time may be used to detect the temperature of each of the plurality of unit head chips.

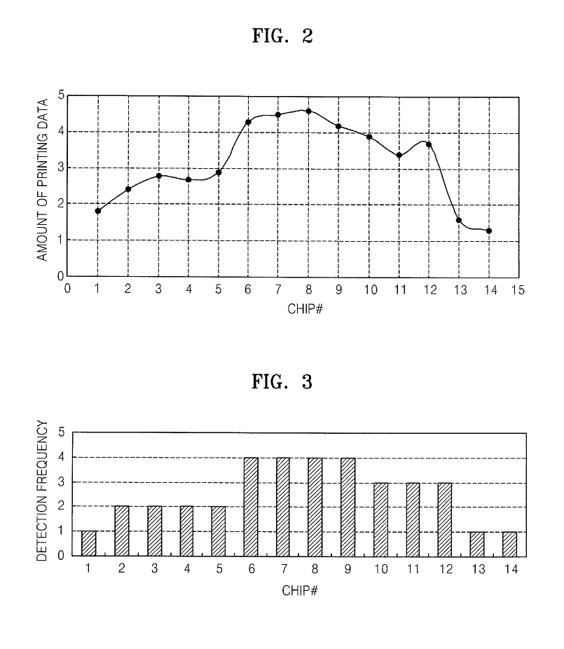

FIG. 3 is a graph illustrating the detection frequencies of temperature information on each of the plurality of unit head chips determined according to the established weight, according to an embodiment of the present general inventive concept. Referring to FIG. 3, the weights included in Table 1 may be used as the actual detection frequencies of temperature information, although different detection frequencies related to the established weights may also be used. With reference to FIGS. 2 and 3, it is illustrated that a relatively large amount of printing data has been allocated to the unit head chips located near the center of the wide array inkjet head having a frequency value of “4”, whereas a relatively small amount of printing data has been allocated to other unit head chips located near the side of the wide array inkjet head having a frequency value of “1” or “2”.

After operation 102 is performed, the temperature information on each of the plurality of unit head chips may be detected according to the determined detection frequency (Operation 104). In operation 104, the temperature information on each of the plurality of unit head chips may be repeatedly detected according to the determined detection frequency using a circulation process.

For example, when the temperature information on each of the plurality of unit head chips is detected using the detection frequency illustrated in FIG. 3, in a first operation, the temperature of the first through fourteenth unit head chips may be detected. In a second operation, the temperature of the second through twelfth unit head chips may be detected. In a third operation, the temperature of the sixth through twelfth unit head chips may be detected. In a fourth operation, the temperature of the sixth through ninth unit head chips may be detected. In this manner, the temperature information on each of the plurality of unit head chips may be detected according to the determined detection frequency by using a circulation process.

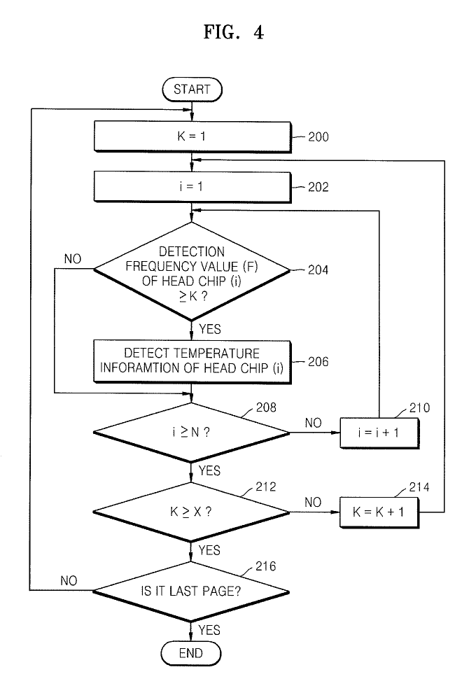

FIG. 4 is a flowchart illustrating operation 104 of FIG. 1. Referring to FIG. 4, K may be set to 1 (Operation 200). K denotes a detection frequency comparative value for the comparison of K and the detection frequency. The detection frequency comparative value K may be between 1 and 4. The value of i may also be set to 1 (Operation 202). i denotes an identification mark of a unit head chip. For example, if a wide array head has fourteen unit head chips, the identification mark i may vary between 1 and 14.

Next, it may be determined whether the detection frequency F of a unit head chip corresponding to the identification mark i is greater than or the same as the detection frequency comparative value K (Operation 204). If it is determined that the detection frequency F of the unit head chip corresponding to the identification mark i is greater than or the same as the detection frequency comparative value K, the temperature information of the unit head chip corresponding to the identification mark i may be detected (Operation 206). It may then be determined whether the identification mark i is smaller than N (Operation 208). N denotes the maximum value of identification mark i of the plurality of unit head chips of the wide array head. If it is determined that the identification mark i is smaller than N, 1 may be added to the identification mark i (Operation 210) and operation 204 may be performed. However, if it is determined that the identification mark i is greater than or the same as N, it may then be determined whether the detection frequency comparative value K is greater than or the same as X (Operation 212). X denotes the maximum value of the determined detection frequency. If it is determined that the detection frequency comparative value K is smaller than X, 1 may be added to the detection frequency comparative value K (Operation 214) and operation 202 may be performed. However, if it is determined that the detection frequency comparative value K is greater than or the same as X, it may be determined whether a page is printed (Operation 216). If it is determined that a page has been completely printed, the process ends. However, if it is determined that a page is not completely printed, the process may be repeated. However, although it may be determined whether to repeatedly perform the process by determining whether a page has been printed in operation 216, it may also be determined whether to repeat the process by determining whether a line has been printed in operation 216.

Operation 104 of FIG. 1 may further comprise an operation to detect temperature information according to an equal detection frequency on all of the unit head chips. For example, when the detection frequency of fourteen unit head chips of a wide array head is determined as illustrated in FIG. 3, the temperature of the first through fourteenth unit head chips may be initially detected as discussed above, and then the temperature of the first through fourteenth unit head chips may be detected irrespective of the detection frequency. Thereafter, the temperature of the second through twelfth unit head chips may be detected according to the detection frequency, and then the temperature of the first through fourteenth unit head chips may be detected irrespective of the detection frequency. Thereafter, the temperature of the sixth through twelfth unit head chips may be detected according to the detection frequency, and then the temperature of the first through fourteenth unit head chips may be detected irrespective of the detection frequency. Thereafter, the temperature of the sixth through ninth unit head chips may be detected according to the detection frequency. In this manner, the temperature information on each of the unit head chips can be detected by using a circulation process based on different or equal detection frequencies.

The above-mentioned methods of the present general inventive concept can also be embodied as computer readable codes/instructions/programs on a computer readable medium. The computer-readable medium can include a computer-readable recording medium and a computer-readable transmission medium. In particular, the present general inventive concept may also provide a computer readable recording medium storing a program to execute a method of detecting an amount of printing data allocated to each of a plurality of unit head chips of the inkjet head, including determining a detection frequency of temperature information on each of the plurality of unit head chips according to the detected amount of printing data, and detecting the temperature information on each of the plurality of unit head chips according to the determined detection frequency.

The computer readable recording medium can be used to realize the present general inventive concept on a general-purpose computer in which the computer readable codes/instructions/programs may be operated. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion. The computer-readable transmission medium can transmit carrier waves or signals (e.g. wired or wireless data transmission through the Internet). Also, functional programs, code and code segments to accomplish the present general inventive concept can be easily construed by programmers skilled in the art to which the present general inventive concept pertains.

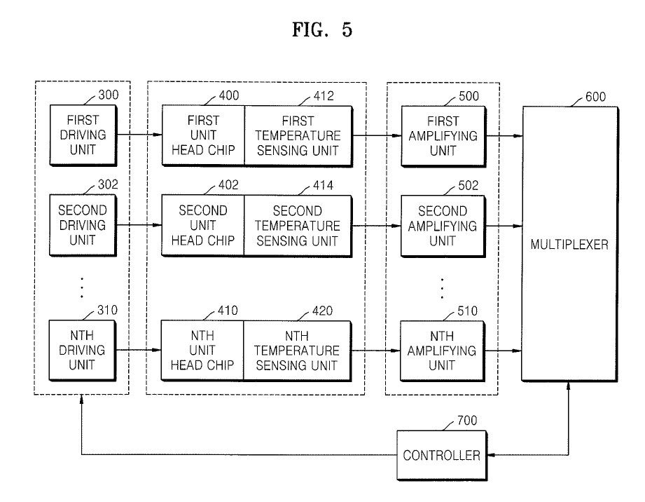

An apparatus to detect the temperature of an inkjet head in accordance with the present general inventive concept will now be described in detail with reference to FIG. 5.

FIG. 5 is a block diagram of an apparatus to detect the temperature of an inkjet head, according to an embodiment of the present general inventive concept. Referring to FIG. 5, an apparatus to detect the temperature of the inkjet head may include first through N^{th} driving units 300 through 310, first through N^{th} unit head chips 400 through 410, first through N^{th} temperature sensing units 412 through 420, first through N^{th} amplifying units 500 through 510, a multiplexer 600, and a controller 700.

Each of the first through N^{th} driving units 300 through 310 may drive an inkjet of each of the first through N^{th} unit head chips 400 through 410. The first through N^{th} driving units 300 through 310 may operate in response to a control signal of the controller 700.

Each of the first through N^{th} temperature sensing units 412 through 420 may be included in each of the first through N^{th} unit head chips 400 through 410. Each of the first through N^{th} temperature sensing units 412 through 420 may include a thermistor.

Each of the first through N^{th} amplifying units 500 through 510 may amplify a result of the temperature sensing performed by each of the first through N^{th} temperature sensing units 412 through 420, and may output an amplification result to the multiplexer 600.

The multiplexer 600 may receive the amplification result of each of the first through N^{th} amplifying units 500 through 510, and may output a result of the temperature sensed by the unit head chips from the received amplification result to the controller 700. Although the above components are described and illustrated separately, those skilled in the art will appreciate that such components may be variously combined and/or integrated with each other to achieve the same or similar results without departing from the broader principles and spirit of the present general inventive concept.

The controller 700 may detect an amount of printing data that is allocated to each of the first through N^{th} unit head chips 400 through 410. In particular, the controller 700 may detect the amount of printing data per page that is allocated to each of the first through N^{th} unit head chips 400 through 410. Furthermore, the controller 700 may detect the amount of printing data per line that is allocated to each of the first through N^{th} unit head chips 400 through 410. A manufacturer or user can determine whether to detect the amount of printing data per page or per line that is allocated to each of the first through N^{th} unit head chips 400 through 410.

The controller 700 may determine a detection frequency of the temperature information on each of the first through N^{th} unit head chips 400 through 410 according to the amount of printing data that is allocated to each of the first through N^{th} unit head chips 400 through 410. The controller 700 may establish a weight in proportion to each amount of printing data in order to determine the detection frequency of the temperature information on each of the first through N^{th} unit head chips 400 through 410.

For example, if a wire array head has fourteen unit head chips as illustrated in FIG. 2, a weight may be allocated to each of the fourteen unit head chips in proportion to each of the amount of printing data as indicated in Table 1. The controller 700 may then use the weight in order to determine the detection frequency of the temperature information on each of the first through N^{th} unit head chips 400 through 410 as illustrated in FIG. 3.

The controller 700 may detect the temperature information on each of the first through N^{th} unit head chips 400 through 410 according to the detection frequency from the multiplexer 600. In particular, the controller 700 may repeatedly detect the temperature information on the first through N^{th} unit head chips 400 through 410 from the multiplexer 600 according to the detection frequency using a circulation process as described above.

For example, when the controller 700 detects the temperature information on each of the plurality of unit head chips using the detection frequency illustrated in FIG. 3, in a first operation, the controller 700 may detect the temperature of the first through fourteenth unit head chips. In a second operation, the controller 700 may detect the temperature of the second through twelfth unit head chips. In a third operation, the controller 700 may detect the temperature of the sixth through twelfth unit head chips. In a fourth operation, the controller 700 may detect the temperature of the sixth through ninth unit head chips. In this manner, the controller 700 may detect the temperature information on each of the plurality of unit head chips by using a circulation process according to the determined detection frequency.

In addition, the controller 700 may further detect temperature information according to an equal detection frequency on all of the unit head chips when detecting the temperature information on each of the first through N^{th} unit head chips 400 through 410 according to the detection frequency from the multiplexer 600.

For example, when the detection frequency of fourteen unit head chips of a wide array head is determined as illustrated in FIG. 3, the controller 700 may detect the temperature of the first through fourteenth unit head chips according to the detection frequency and then may detect the temperature of the first through fourteenth unit head chips irrespective of the detection frequency from the multiplexer 600. The controller 700 may repeatedly perform the detection operation according to the detection frequency.

The methods and apparatus to detect the temperature of an inkjet head according to the present general inventive concept may be used to control a temperature frequency of each of a plurality of unit head chips included in an inkjet printer, thereby more exactly sensing the temperature of each unit head chips based on the amount of printing data allocated to each unit head chip compared with conventional methods which merely sense temperature according to the same temperature frequency.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of detecting the temperature of an inkjet head, comprising:
detecting an amount of printing data allocated to each of a plurality of unit head chips of the inkjet head;
determining a detection frequency of temperature information on each of the plurality of unit head chips according to the detected amount of printing data; and
detecting the temperature information on each of the plurality of unit head chips according to the determined detection frequency.

2. The method of claim 1, wherein the amount of printing data per page allocated to each of the plurality of unit head chips is detected.

3. The method of claim 1, wherein the amount of printing data per line allocated to each of the plurality of unit head chips is detected.

4. The method of claim 1, wherein the detection frequency of temperature information on each of the plurality of unit head chips is determined by establishing a weight for each of the plurality of unit head chips in proportion to each amount of printing data.

5. The method of claim 1, wherein the temperature information on each of the plurality of unit head chips is repeatedly detected according to the determined detection frequency using a circulation process.

6. The method of claim 1, wherein detecting the temperature information further comprises:
detecting temperature information on the plurality of unit head chips according to an equal detection frequency.

7. A computer readable recording medium having embodied thereon a computer program to execute a method of detecting the temperature of an inkjet head, the method comprising:
detecting an amount of printing data allocated to each of a plurality of unit head chips of the inkjet head;
determining a detection frequency of temperature information on each of the plurality of unit head chips according to the detected amount of printing data; and
detecting the temperature information on each of the plurality of unit head chips according to the determined detection frequency.

8. An apparatus to detect temperature of an inkjet head, comprising:
a sensing unit to sense the temperature of a plurality of unit head chips of the inkjet head; and
a control unit to establish a detection frequency based on an amount of printing data allocated to each unit head chip, and to detect the temperature of each unit head chip from the sensing unit based on the established detection frequency.

9. The apparatus of claim 8, wherein the control unit alternates between an equal detection frequency and the established detection frequency when detecting the temperature of each unit head chip.

10. The apparatus of claim 8, wherein the detection frequency varies according to the location of each unit head chip with respect to the inkjet head.

11. The apparatus of claim 8, wherein the control unit repeatedly detects the temperature of each unit head chip until a page of printing data is completely printed.

12. The apparatus of claim 8, wherein the control unit repeatedly detects the temperature of each unit head chip until a line of printing data is completely printed.

13. The apparatus of claim 8, wherein the control unit establishes a weight for each of the plurality of unit head chips in proportion to each amount of allocated printing data and determines the detection frequency based on the established weights.

14. The apparatus of claim 8, wherein the control unit repeatedly detects the temperature of each of the plurality of unit head chips according to the determined detection frequency using a circulation process.

15. The apparatus of claim 8, wherein the control unit further detects temperature information on the plurality of unit head chips according to an equal detection frequency when detecting the temperature of each of the plurality of unit head chips.

16. The apparatus of claim 8, further comprising:
an amplification unit to amplify the temperature result sensed by the sensing unit.
